(19) United States
(12) Patent Application Publication
(10) Pub. No.: US 2010/0282934 A1
(43) Pub. Date: Nov. 11, 2010

(54) ADJUSTABLE WALL CUPBOARD HOLDER GROUP FOR ANCHORING A CUPBOARD TO THE WALL

(75) Inventor: Carlo Cattaneo, Figino Serenza-Como (IT)

Correspondence Address: HEDMAN & COSTIGAN, P.C., 1230 AVENUE OF THE AMERICAS, 7th floor, NEW YORK, NY, 10020, US

(73) Assignee: LEONARDO S.r.l., Figino Serenza- Como (IT)

(21) Appl. No.: 12/735,291

(22) PCT Filed: Jul. 24, 2009
(86) PCT No.: PCT/EP2009/005627

§ 371 Date: Jun. 29, 2010

(30) Foreign Application Priority Data
Jul. 29, 2008 (IT) MI2008A001393

(51) Int. Cl. F16M 13/02

(52) U.S. Cl. 248/222.14; 248/225.21

(57) ABSTRACT

An adjustable wall cupboard holder group (10) for anchoring a cupboard (11) to the wall comprises a hook (15) situated at the free end of a hooking element or arm (14) extending externally from said wall cupboard holder group. A regulation mechanism of the positions in depth and height of said hook (15) is associated with said arm (14). Said wall cupboard holder group comprises a central section or portion (16) containing said arm (14) and mechanism, and two side sections or flanges (18, 18′), at least one element (20, 20′) resistant to shear forces, protruding from at least one of said sections, whereas at least the other section comprising at least one fixing device (19, 19′).

The present invention relates to a visible wall cupboard holder group, adjustable for anchoring a cupboard to the wall.

In particular, the wall cupboard holder in question is defined as being visible as it is destined for being assembled inside a wall cupboard.

Wall cupboard holders in which a hook is situated at the free end of an arm which extends externally from a box-shaped body made of plastic material, are well known to experts in the field.

Said box-shaped body contains a mechanism for regulating the positions in depth and height of the hook, which is to be hooked to a wall support, a shaped metallic section, peg or other similar item.

The wall cupboard holder thus structured is fixed to the shoulder of the cupboard by means of self-threading screws, or pressure-yielding plugs made of a plastic material, with a saw-toothed profile, in correspondence with the upper edges of the cupboard, defined by the shoulder, cover or top.

The screws are pass-through, i.e. they pass through the box-shaped body and are screwed directly into the shoulder of the cupboard, whereas the plugs extend integrally and laterally from the box-shaped body made of plastic material and are pressure-inserted into a corresponding seat of the shoulder.

A wall cupboard holder of the type briefly described above is described and illustrated, for example, in patents EP 0033179 B1 and EP 0632979 A1.

There are also other types of wall cupboard holders which substantially differ in the supports with which they are fixed to the cupboards and also in the means with which it is possible to regulate the positions in depth and height (inclination) of the rear hook.

These wall cupboard holders, described for example in EP 1228720 B1, at present generally consist of a plate element equipped with a side flange which, in the assembly phase, is normally fixed by means of screws or expansion pegs in holes situated on the shoulder of the wall cupboard.

As mentioned above, the above known wall cupboard holders comprise a moveable hook element for fixing the cupboard to the wall which, as described in EP 1228720 B1, is driven by screw-female screw mechanisms, possibly equipped with angular countershafts, capable of allowing the regulation of the rear position of the supporting hook (see also EP 0033179 B1 and EP 0632979 A1).

Although these known wall cupboard holders are currently functional and satisfy the safety regulations in force in the field of hanging furniture items, in view of the present tendency to reduce the thicknesses of the panels forming wall cupboards and increasing diffusion of these pieces of furniture, which are also frequently overloaded, it can unfortunately happen that this cupboard/cupboard holder coupling is not always effective, long-lasting and above all safe.

As the stability of the wall cupboard depends on this constraint, unfortunately the wall cupboard frequently falls dangerously and/or breaks as a result of the shear forces acting in the wall cupboard holder coupling which are generated when the cupboard is loaded.

The above drawbacks mainly occur in the wall cupboard holders of EP 0033179 B1 and EP 0632979 A1, with a box-shaped body made of plastic material.

A general objective of the present invention is to solve the above drawbacks of the known art in an extremely simple, economical and particularly functional manner.

A further objective is to provide a visible wall cupboard holder group for anchoring a wall cupboard to the wall, which ensures an easy and firm assembly on any type of wall cupboard.

Another objective is to provide a visible wall cupboard holder group for anchoring a wall cupboard to the wall, which is capable of resisting high shear forces which can be generated in the cupboard/wall cupboard holder coupling once the cupboard has been loaded.

In view of the above objectives, according to the present invention, a visible wall cupboard holder group has been conceived for anchoring a cupboard to the wall, having the characteristics specified in the main claim and enclosed subclaims.

The structural and functional characteristics of the of the present invention, and its advantages with respect to the known art, will appear more evident from the following description, referring to the enclosed schematic drawings, which illustrate examples of visible wall cupboard holder groups for anchoring a wall cupboard to the wall produced according to the innovative principles of the same invention.

### IN THE DRAWINGS

FIG. 1 is an exploded view of a visible wall cupboard holder group for anchoring a wall cupboard to the wall according to the present invention;

FIG. 2 is a perspective view of the wall cupboard holder group of FIG. 1 assembled;

FIG. 2b is another perspective view of the wall cupboard holder group of FIG. 2;

FIG. 2c is an enlarged view of a detail of the wall cupboard holder group of FIGS. 2-2b assembled on the relative wall cupboard;

FIG. 3 is a perspective view of another wall cupboard holder group according to the present invention;

FIG. 3b is another perspective view of the wall cupboard holder group of FIG. 3;

FIG. 3c is an enlarged view of a detail of the wall cupboard holder group of FIGS. 3-3b assembled on the relative wall cupboard;

FIG. 4 is a perspective view of another wall cupboard holder group according to the present invention;

FIG. 4b is another perspective view of the wall cupboard holder group of FIG. 4;

FIG. 4c is an enlarged view of a detail of the wall cupboard holder group of FIGS. 4-4b assembled on the relative wall cupboard;

FIG. 5 is a perspective view of another wall cupboard holder group according to the present invention;

FIG. 5b is another perspective view of the wall cupboard holder group of FIG. 3;

FIG. 5c is an enlarged view of a detail of the wall cupboard holder group of FIGS. 5-5b assembled on the relative wall cupboard;

FIG. 6 is a perspective view of another wall cupboard holder group according to the present invention;

FIG. 6b is another perspective view of the wall cupboard holder group of FIG. 3;

FIG. 6c is an enlarged view of a detail of the wall cupboard holder group of FIGS. 6-6b assembled on the relative wall cupboard;

FIG. 7 is a perspective view of the wall cupboard holder group according to the present invention in the assembly phase on the relative wall cupboard;

FIG. 7b is a perspective view of the wall cupboard holder group of FIG. 5 assembled on the relative wall cupboard;

FIG. 8 is a perspective view of another wall cupboard holder group according to the present invention in the assembly phase on the relative wall cupboard;

FIG. 8b is a perspective view of the wall cupboard holder group of FIG. 8 assembled on the relative wall cupboard.

With reference to the drawings, a visible adjustable wall cupboard holder group for anchoring a cupboard to the wall in question is indicated as a whole with 10.

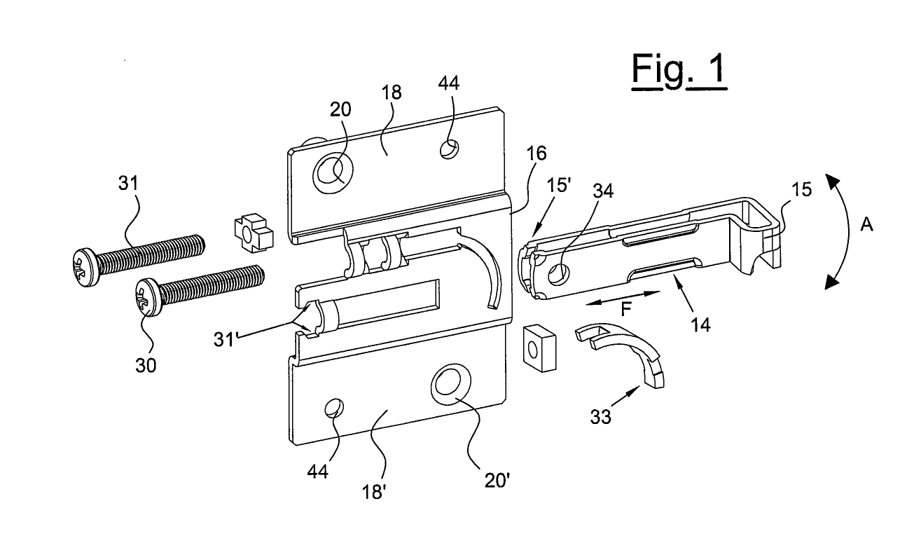

Said wall cupboard holder group 10 visible in exploded form in FIG. 1 and suitable for effecting the anchoring of a wall cupboard 11 to a wall, is fixed during use on one side to a shoulder 12 of the relative wall cupboard 11 and on another, which at least partially protrudes externally from a hole 40 situated on a rear cover 13 of the same cupboard to a support (generally a metallic section) fixed to the wall (generally a metallic section).

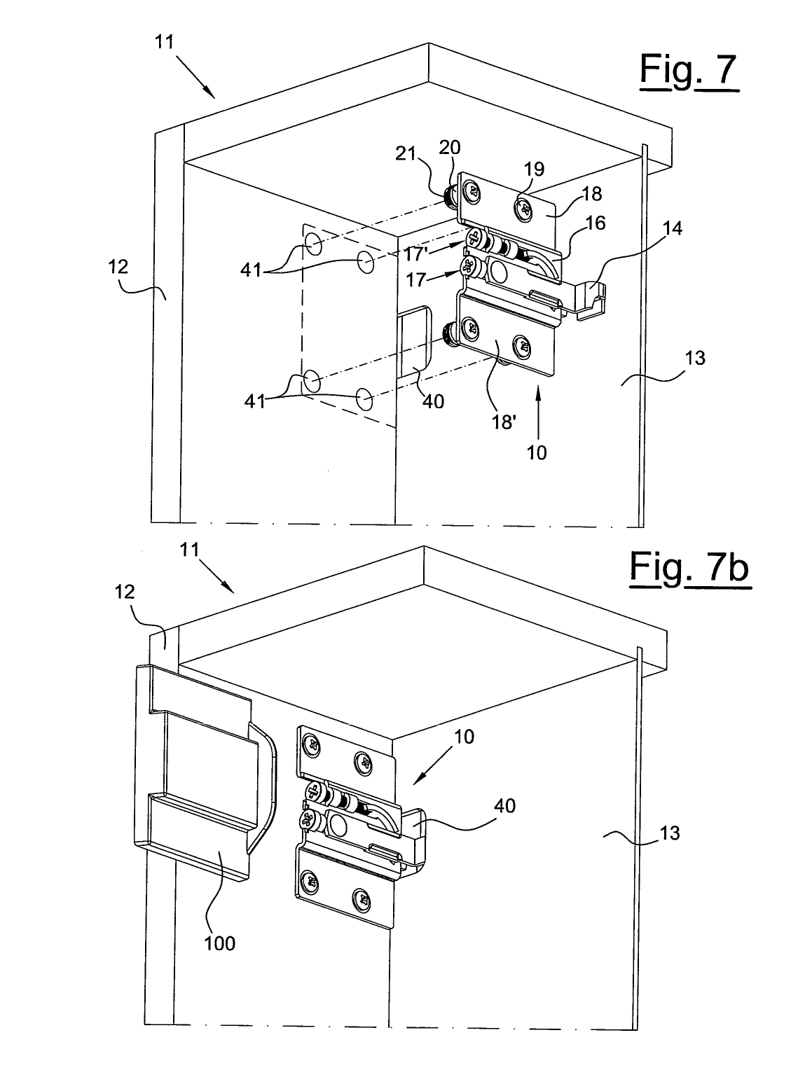

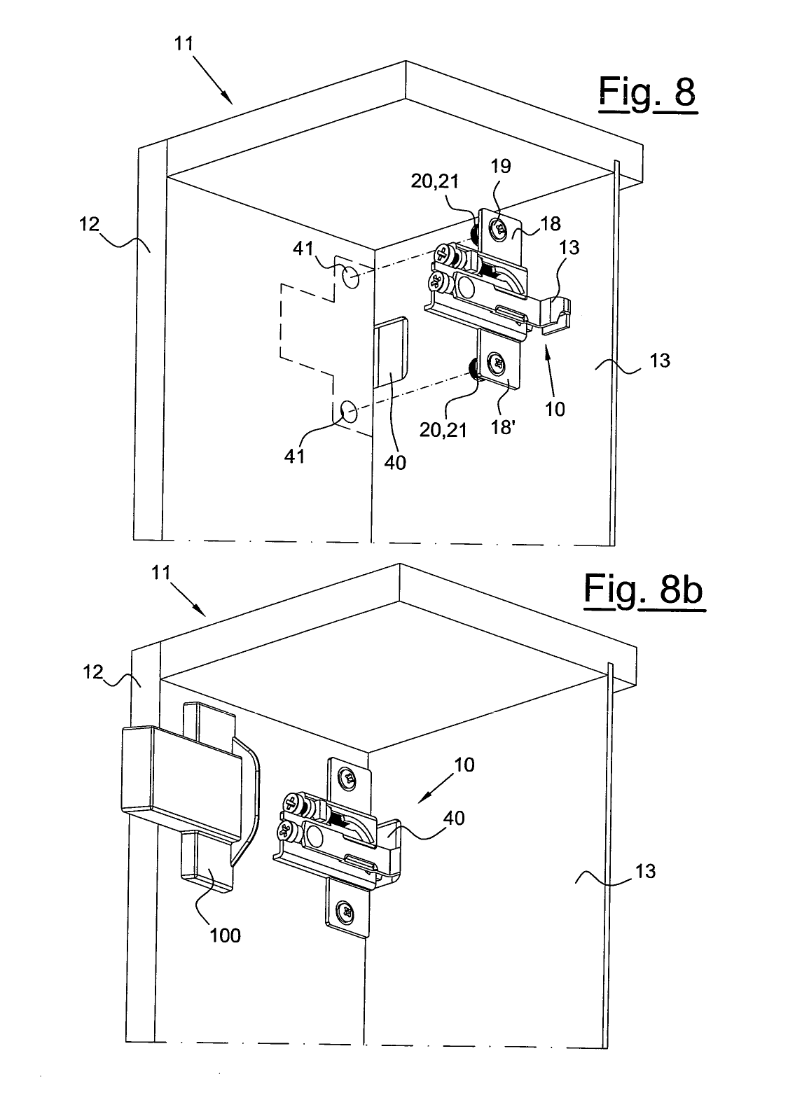

An example of these assembly phases and relative couplings of the wall cupboard holder 10 in both the rear hole 40 and in the side holes 41 of the wall cupboard 11 are shown in FIGS. 7 and 8, whereas FIGS. 7b and 8b illustrate the same wall cupboard holders 10 at the end of the assembly with the relative rear portions 15 protruding beyond the cover 13 of the wall cupboard 11.

As can be easily seen, according to an embodiment of the invention, there is also a covering top 100, generally made of plastic, of the wall cupboard holder 10, which, however, has no structural function.

In particular, as clearly shown in FIG. 1, the wall cupboard holder 10 according to the invention comprises a hooking element 14 to a supporting element fixed to the wall, said hook 14 is coupled at a first end 15′ to a central portion 16 of a plate element whereas at a second end, which freely protrudes behind the central portion 16, there is a hook-shaped fixing portion 15 to the above support.

In order to allow regulations of the position of the hook-shaped portion 15, the connection of the hooking element 14 to the central portion 16 is of the adjustable type in depth F and inclination A. For this purpose, regulation means 17, 17′ of the depth F and inclination A of the hooking element 14 are envisaged, said means 17, 17′ are associated with and easily accessible in the front to the central portion 16.

In this way, the user can proceed with all the regulations of the cupboard which he feels are necessary, in depth and height, as is well-known to experts in the field.

According to the invention, the wall cupboard holder 10 as described above, also comprises two side flanges 18, 18′ which extend from the central portion 16 from opposite parts, above and below the hooking element 14, respectively, in which each of the two side flanges 18, 18′ comprising fixing means 19, 19′ of the wall cupboard holder group 10 to the inner side wall 12 (shoulder) of the wall cupboard 11, in addition to at least one element resistant to the shear forces 20, 20′ which are generated when the wall cupboard holder 10 is assembled and when the wall cupboard is loaded.

Said at least one element resistant to shear forces 20, 20′ protrudes from the side flanges 18, 18′ on the side facing the inner side wall 12 of the wall cupboard 11, and collaborates with the previous fixing means 19, 19′ for a stable positioning of the wall cupboard holder 10 on an internal wall 12 of the wall cupboard 11.

As can be seen in FIG. 1, the regulation means 17, 17′ of the depth F and inclination A of the hooking element 14, which, as already mentioned, are associated with and easily accessible in the front to the central portion 16, comprise two screw-female screw mechanisms.

In these mechanisms, there is a first regulation screw 30 which comprises a head which is firmly housed/entrapped in a counter-form 31 situated in the first portion 16 and a threaded development which is longitudinally associated in an internal threaded seat of the hooking element 14 in correspondence with the end 15′ of the hooking element 14 opposite the hook 15.

As can be deduced from what is stated above, said first regulation screw 30 is able to regulate the longitudinal movement (depth) of the hooking element 14.

A second regulation screw 31 is also envisaged, which is associated with the first central portion 16 in a parallel and upper position with respect to the first regulation screw 30.

Said second regulation screw 31 acts on a movable circular lunette 33 situated at the opposite side with respect to the head of the second regulation screw 31 and is driven by the second regulation screw 31 to enforce a rotation of the hooking element 14 around a riveted pin 34.

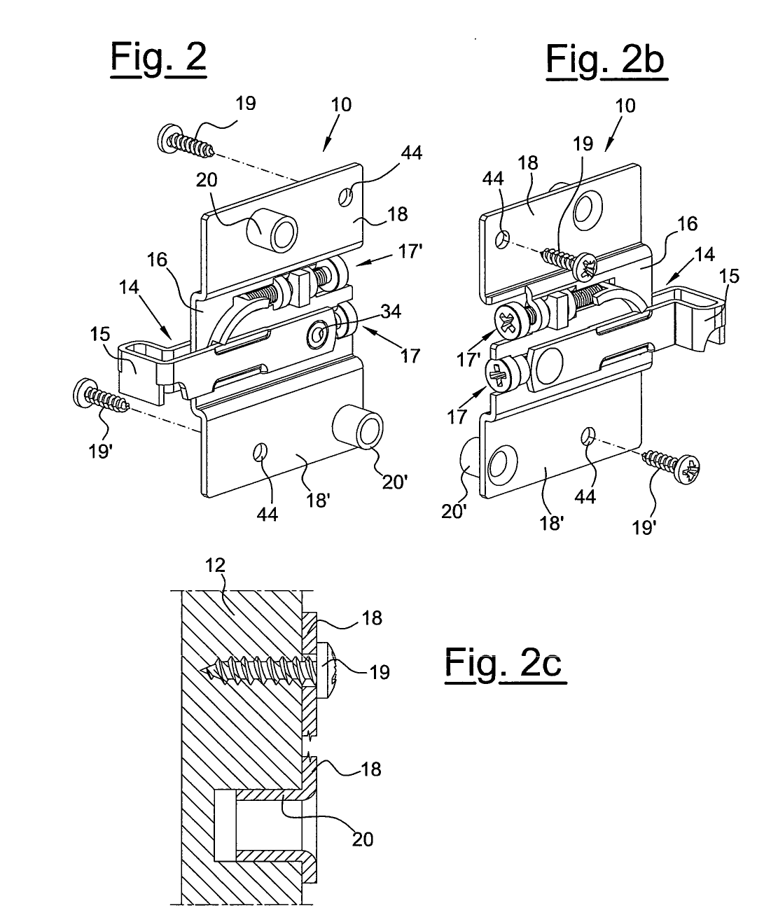

According to an embodiment shown in FIGS. 2-2c, the elements resistant to shear forces 20, 20′ comprise at least one plug element 20, 20′ protruding from the side flanges 18, 18′ which are coupled, not necessarily forcedly (i.e. not necessarily with interference), with holes 41 situated in the internal side wall 12 of the wall cupboard 11.

As shown in FIG. 2c, said plugs 20, 20′ collaborate with the previous fixing means 19, 19′, for example screws, for a stable positioning of the wall cupboard holder 10 on the internal side wall 12 of the wall cupboard 11, preventing the misalignment of the wall cupboard holder 10 with respect to the relative wall cupboard 11.

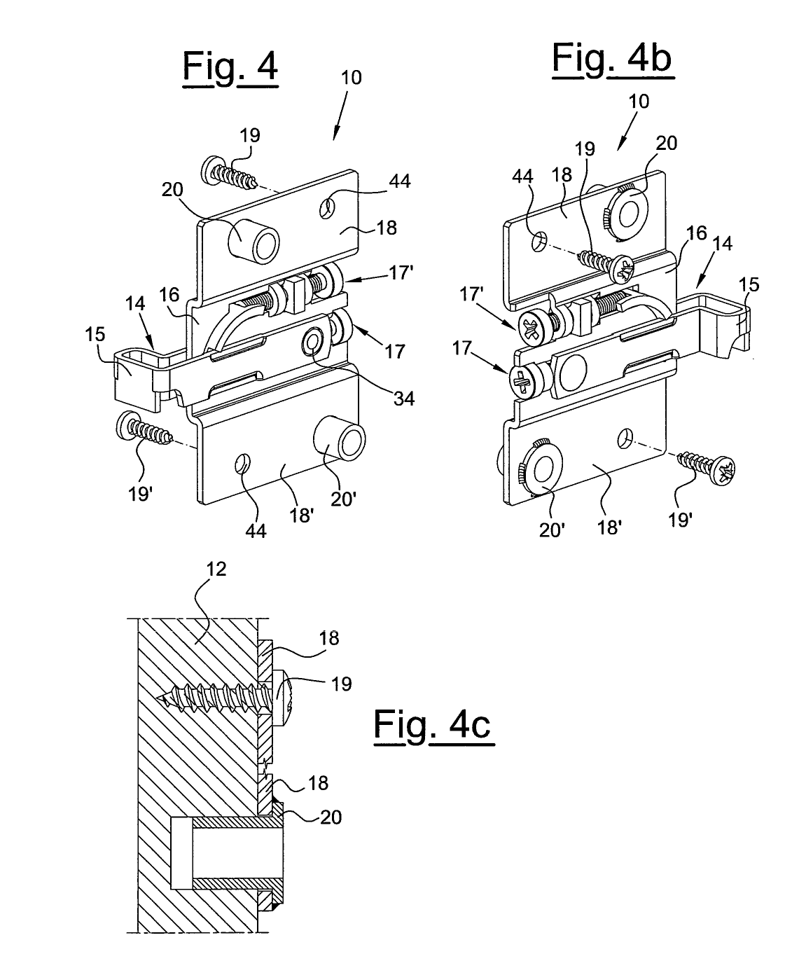

In the above embodiment, the plug elements 20, 20′ are integrally positioned directly on the side flanges 18, 18′ during the production of the wall cupboard holder 10, but alternatively they can also be produced separately and subsequently welded onto the side flanges 18, 18′ as shown in the embodiment of FIGS. 4-4c.

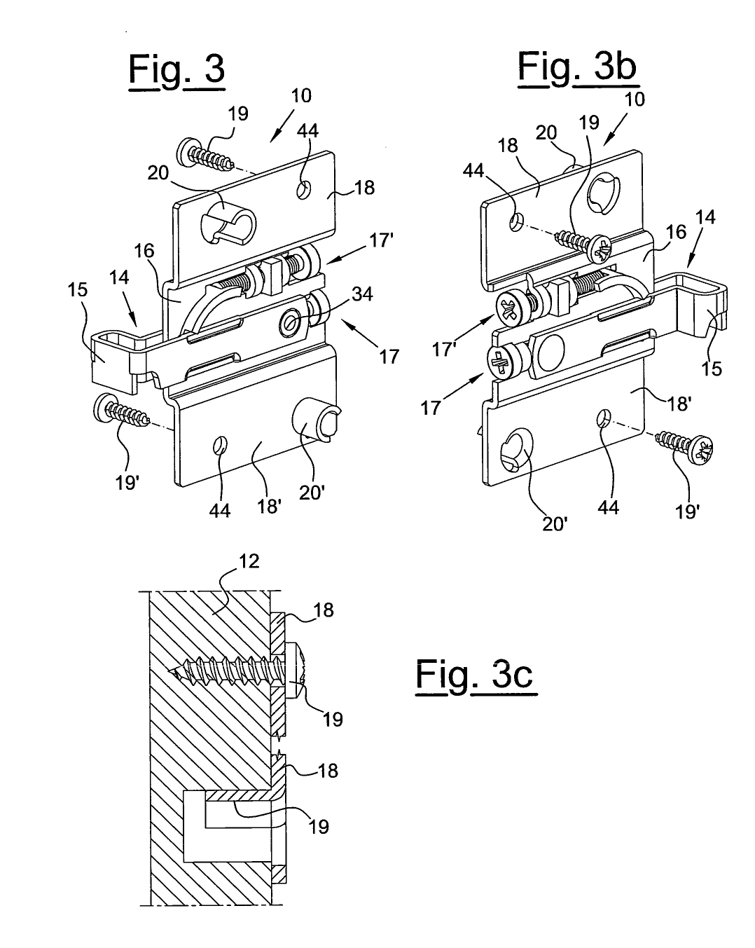

The plug elements so far described are preferably hollow cylindrical plugs with a circular section but, alternatively, and in relation to the type of cupboard to be coupled with the wall cupboard holder 10, they can be hollow cylindrical plugs having a circumferential arc section as shown in the embodiments of FIGS. 3-3c.

As already specified, the fixing means 19, 19′ can comprise at least one fixing screw 19, 19′ of the side flanges 18, 18′ to the internal side wall 12 of the wall cupboard 11 in which said at least one fixing screw 19, 19′ can be coupled with the side flanges 18, 18′ in different positions with respect to the at least one plug element 20, 20′ through relative holes 44.

Alternatively, the above screws 19, 19′ can be coupled with the side flanges 18, 18′ inside the plug elements 20, 20′.

According to another embodiment of the invention, the wall cupboard holder group 10 can comprise, as fixing means 19, 19′, at least one expansion peg 21, 21′ which can be optionally, but not necessarily, activated (radially expandable) by means of the screws 19, 19′ and equipped with gripping teeth which, like the screws 19, 19′ of the previous examples, fix the side flanges 18, 18′ to the internal side wall 12 of the wall cupboard 11.

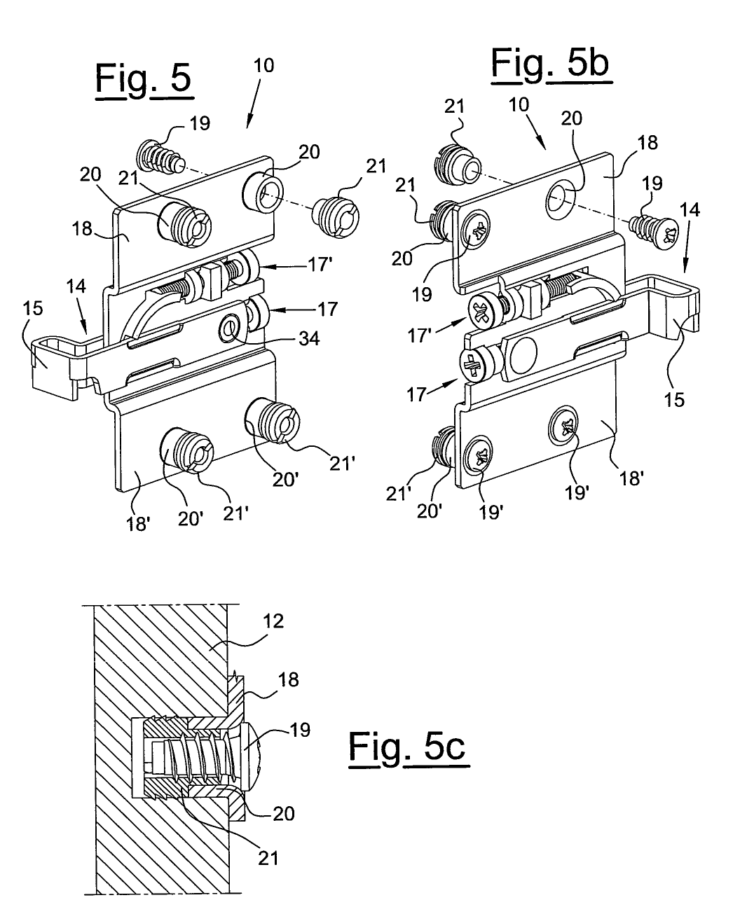

Said pegs 21, 21′ can be coupled with the side flanges 18, 18′ either in different positions with respect to the at least one plug element 20, 20′, or, as shown in FIGS. 5-5c, coaxially with the relative screws 19, 19′ to the at least one plug element 20, 20′.

Finally, according to a last embodiment, the fixing means comprise at least one expansion peg 21, 21′ by means of cursors 22 with shaped heads which, like the previous pegs, fix the side flanges 18, 18′ to the internal side wall 12 of the wall cupboard 11.

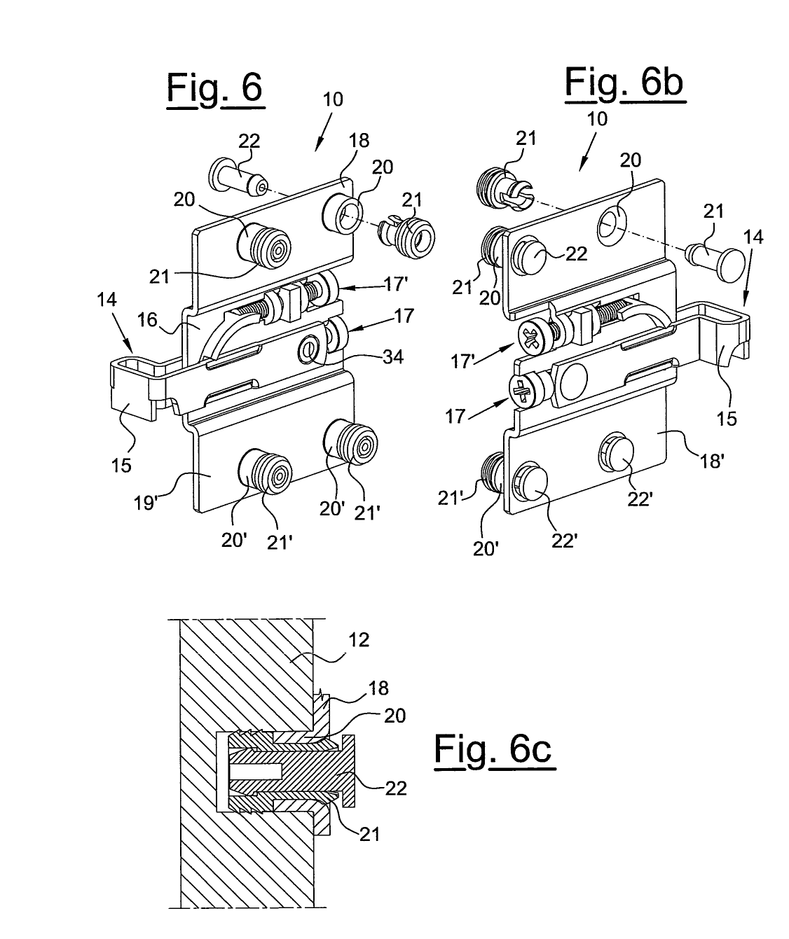

These pegs 21, 21′ can also be coupled with the side flanges 18, 18′ either in different positions or coaxially to the at least one plug element 20, 20′ as shown in FIGS. 6-6c.

From the above description with reference to the figures, it is evident how a visible wall cupboard holder group for anchoring a wall cupboard to the wall according to the invention is particularly useful and advantageous. The objective indicated in the preamble of the invention has therefore been achieved.

The visible adjustable wall cupboard holder 10 for the assembly of a wall cupboard to a wall according to the present invention, in fact, ensures an easy and firm assembly on any type of wall cupboard preventing any possible misalignment of the wall cupboard holder 10 itself with respect to the relative cupboard also when the latter is loaded.

This firm positioning can be obtained and maintained in any loading condition of the cupboard thanks to the presence of the elements resistant to shear forces 20, 20′ protruding from the side flanges 18, 18′ inserted in the holes 41 of the internal side wall 12 of the wall cupboard 11.

In this condition, said elements resistant to shear forces 20, 20′, such as cylindrical plugs, collaborate with the fixing means 19, 19′, such as screws or expansion pegs and/or equipped with gripping teeth, to ensure a stable positioning of the wall cupboard holder group 10 on the internal wall 12 of the wall cupboard 11.

The forms of the visible wall cupboard holder group for the fixing of a wall cupboard to a wall, of the invention, as also the materials, can differ from those shown for purely illustrative and non-limiting purposes in the drawings.

The protection scope of the invention is therefore delimited by the enclosed claims.

1. An adjustable wall cupboard holder group (10) for anchoring a cupboard (11) to the wall comprising a hook (15) situated at the free end of a hooking element or arm (14) extending externally from said wall cupboard holder group, a regulation mechanism of the positions in depth and height of said hook (15) being associated with said arm (14), characterized in that said wall cupboard holder group comprises a central section or portion (16) containing said arm (14) and mechanism, and two side sections or flanges (18, 18′), at least one element (20, 20′) resistant to shear forces, protruding from at least one of said sections, whereas at least the other section comprising at least one fixing device (19, 19′).

2. The adjustable wall cupboard holder group (10) according to claim 1, for the anchoring of a wall cupboard (11) to a wall and suitable for being coupled on one side to a shoulder (12) of said wall cupboard (11) and on the other side with a support fixed to the wall, said wall cupboard holder (10) comprising a hooking element (14) to said supporting organ fixed to the wall coupled at a first end to a central portion (16) of said wall cupboard holder (10) so that it is adjustable in depth and inclination (height) and equipped with a second free end protruding from behind said central portion (16) and hook-shaped (15) for fixing to said support, there also being regulation means (17, 17′) of the depth and inclination of said hooking element (14) associated with and accessible in the front to said central portion (16), characterized in that said wall cupboard holder (10) comprises two side flanges (18, 18′) which extend from said central portion (16) from opposite parts, said two side flanges (18, 18′) each comprising fixing means (19, 19′) of said wall cupboard holder group (10) onto said internal side wall (12) of said wall cupboard (11) and at least one element resistant to shear forces (20, 20′) protruding from said side flanges (18, 18′) towards said internal side wall (12) of said wall cupboard (11), said at least one element resistant to shear forces (20, 20′) collaborating with said fixing means (19, 19′) for a stable positioning of said wall cupboard holder group (10) onto said internal side wall (12) of said wall cupboard (11).

3. The adjustable wall cupboard holder group (10) according to claim 2, characterized in that said regulation means (17, 17′) of the depth and inclination of said hooking element (14) associated with and accessible in the front to said central portion (16) comprise two screw-female screw mechanisms in which the head of a first regulation screw (30) is firmly housed in a counter-form (31) situated in said first portion (16), said first regulation screw (30) being longitudinally associated in an internal threaded seat of said hooking element (14) at an end (15′) opposite to said hook (15) for the longitudinal movement of said hooking element (14), a second regulation screw (31) being envisaged, which is associated with said central portion (16) in a parallel and upper position with respect to said first regulation screw (30), said second regulation screw (31) acting on a movable circular lunette (33) enforcing a rotation of said hooking element (14) around a riveted pin (34).

4. The adjustable wall cupboard holder group (10) according to claim 3, characterized in that said at least one element resistant to shear forces (20, 20′) comprises at least one plug element (20, 20′) protruding from said side flanges (18, 18′) coupled with holes situated in said internal side wall (12) of said wall cup-board (11).

5. The adjustable wall cupboard holder group (10) according to claim 4, characterized in that said at least one plug element (20, 20′) is integral with said side flanges (18, 18′).

6. The adjustable wall cupboard holder group (10) according to claim 4, characterized in that said at least one plug element (20, 20′) is welded onto said side flanges (18, 18′).

7. The adjustable wall cupboard holder group (10) according to claim 4, characterized in that said at least one plug element (20, 20′) is a hollow cylindrical plug with a circular section.

8. The adjustable wall cupboard holder group (10) according to claim 4, characterized in that said at least one plug element (20, 20′) is a hollow cylindrical plug with a circumferential arc section.

9. The adjustable wall cupboard holder group (10) according to claim 4, characterized in that said fixing means (19, 19′) comprise at least one fixing screw of said side flanges (18, 18′) to said internal side wall (12) of said wall cupboard (11), said at least one screw being coupled with said side flanges (18, 18′) in different positions with respect to at least one plug element (20, 20′).

10. The adjustable wall cupboard holder group (10) according to claim 4, characterized in that said fixing means (19, 19′) comprise at least one fixing screw of said side flanges (18, 18′) to said internal side wall (12) of said wall cupboard (11), said at least one screw being coupled with said side flanges (18, 18′) inside said at least one plug element (20, 20′).

11. The adjustable wall cupboard holder group (10) according to claim 4, characterized in that said fixing means (19, 19′) comprise at least one expansion peg (21, 21′) by means of screws (19, 19′) with gripping teeth for fixing said side flanges (18, 18′) to said internal side wall (12) of said wall cupboard (11), said at least one peg (21, 21′) being coupled with said side flanges (18, 18′) in different positions with respect to at least one plug element (20, 20′).

12. The adjustable wall cupboard holder group (10) according to claim 4, characterized in that said fixing means (19, 19′) comprise at least one expansion peg (21, 21′) by means of fixing screws of said side flanges (18, 18′) to said internal side wall (12) of said wall cupboard (11), said at least one peg (21, 21′) being coupled with said side flanges (18, 18′) coaxially to said at least one plug element (20, 20′) and said screws inside said at least one plug element (20, 20′).

13. The adjustable wall cupboard holder group (10) according to claim 4, characterized in that said fixing means comprise at least one expansion peg (21, 21′) by means of cursors (22) with a shaped fixing head of said side flanges (18, 18′) to said internal side wall (12) of said wall cupboard (11), said at least one expansion peg (21, 21′) being coupled with said side flanges (18, 18′) coaxially to said at least one plug element (20, 20′) and said cursors (22) inside said at least one plug element (20, 20′).
